(19) United States
(12) Patent Application Publication
(10) Pub. No.: US 2006/0100948 A1
(43) Pub. Date: May 11, 2006

(54) Methods for creating and valuating intellectual property rights-based financial instruments

(76) Inventors: Raymond Millien, South Orange, NJ (US); Benedict O. Okoh, New York, NY (US)

Correspondence Address: FISH & RICHARDSON P.C., P.O. BOX 1022, MINNEAPOLIS, MN, 55440-1022, US

(21) Appl. No.: 11/327,811

(22) Filed: Jan. 6, 2006

(51) Int. Cl. G06Q 40/00

(52) U.S. Cl. 705/35

(57) ABSTRACT

Systems, methods and computer program products for creating and valuating intellectual property rights-based financial instruments, including patent futures, options, swaps, and the like, are disclosed. In an embodiment, the present invention provides a “patent derivative” to allow investors (e.g., venture capitalist) to hedge their risk in investing in a high-technology, start-up company with no issued patents, but with one or more pending patent applications. The system includes databases for IP rights and financial information, as well as a central processing trading server that is accessible via internal and external workstations. The workstations provide a graphical user interface to enter a series of inputs and receive information (i.e., output) concerning such a financial instrument. The method and computer program product involve collecting the series of inputs affecting the value of the financial instrument and applying a pricing model modified to account for some aspect of potential intellectual property (e.g., patent) rights.

### BACKGROUND OF THE INVENTION

A. Financial Instruments and Risk

In today's financial markets, the use of financial instruments known as “derivatives” have exponentially grown and is now common place. A derivative is a financial instrument (which may be used as an investment vehicle) whose value is based on the value of another security or underlying asset. That is, a derivative is essentially a financial instrument whose value is derived from the future movement of something that cannot be predicted with certainty. A derivative is a contractual relationship established by two or more parties where payment is based on (i.e., derived from) some agreed-upon benchmark. By the late 1990's the Office of the Comptroller of the Currency estimated that commercial banks in the United States alone, held over $20T worth of derivative-based assets. Common examples of derivatives include futures contracts, forward contracts, options, and swaps, all of which are briefly explained below.

Forward and futures contracts (the latter of which are standardized and may be exchange-traded) are transferable agreements to buy or sell a commodity (e.g., a particular crop, livestock, oil, gas, interest rate, etc.). These contracts typically involve two parties agreeing upon the manner, place and time of delivery of a certain size, quantity, etc. of a certain asset.

Options contracts are agreements, that may be exchange-traded, among two parties that represent the right to buy or sell a specified amount of an underlying security, asset, or financial instrument (e.g., a stock, bond, currency, futures contract, etc.) at a specified price within a specified time. The parties of options contracts are purchasers who acquire “rights,” and sellers who assume “obligations.” Further, a “call” option contract is one giving the owner the right to buy, whereas a “put” option contract is one giving the owner the right to sell the underlying security, asset or financial instrument. There is typically an up-front, non-refundable premium that the buyer pays the seller to obtain the option rights.

Swaps allow entities to exchange variable cash flows for fixed payments. They are similar to options but no premium (i.e., up-front money) is paid to obtain the rights. It is essentially an outright trade based on the expected movement of the price of the derivative's underlying asset.

Derivatives are typically used by institutional investors to increase overall portfolio return or to hedge or revoke portfolio risks. Derivatives are also frequently used by banks, companies, organizations, and the like to protect against market, currency or other risks in general. For example, utility companies may be interested in protecting against meeting heating or cooling demands when unexpected weather occurs, and banks may be interested in protecting against the risk of loan defaults. Derivatives help in managing risks by allowing such banks, companies, organizations and the like to divide their risk into several pieces that may be passed off to other entities who are willing to shoulder the risk for an up-front fee or future payment stream.

Derivatives, being financial instruments, may be traded among investors as are stocks, bonds and the like. Thus, in order to trade derivatives, there must be a mechanism to price them so that traders may exchange them in an open market.

The relationship between the value of a derivative and the underlying asset are not linear and can be very complex. Economists have developed pricing models in order to valuate certain types of derivatives. For example, as is well known in the relevant art(s), the Black-Scholes option pricing model is the most influential and extensively used pricing model. The Black-Scholes model is based on stochastic calculus and is described in detail in a variety of publicly available documents, such as Chriss, Neil A., The Black-Scholes and Beyond Interactive Toolkit: A Step-by-Step Guide to In-depth Option Pricing Models, McGraw-Hill, 1997, ISBN: 078631026X (USA), which is incorporated herein by reference in its entirety.

B. Small Business (Start-Ups) and Innovation

A “small business” is commonly defined as an independent company having fewer than 500 employees. According to the U.S. Small Business Administration (SBA), in 2001, such small businesses represent 99.7% of all employers, accounted for nearly 50% of all private sector jobs and paid 44.3% of the total U.S. private payroll. More specifically, small businesses employ 29 percent of high-tech workers such as scientists, engineers and computer workers.

In a 2003 study by CHI Research, Inc., entitled “Small Serial Innovators: The Small Firm Contribution to Technical Change,” it was concluded that small businesses are effective innovators and may very well be the most important to the U.S. economy as agents of change signaled by the fact that the small firm contribution to innovation is most intense in new technologies. Small businesses often pursue leading-edge technical niches. Small businesses, on average, produce more highly-cited patents than large businesses, are twice as closely linked to scientific research than large firm innovation, produce at least 13 times more patents per employee as large businesses, and their patents are twice as likely as large firm patents to be among the top 1% most-cited patents.

C. Risk Faced by Investors

Undoubtedly, obtaining financing is difficult for most small business start-ups. (See generally, Donald H. Macadam, “Startup to IPO: How to Build and Finance a Technology Company” (Xlibris 2003), ISBN 1-4134-3890-3, incorporated herein by reference in its entirety.) Those start-ups businesses that have not yet produced a product, typically seek “seed” financing from professional investors or a lender. “Bootstrapping” financing is available using the personal assets of the start-up's founders. This includes any source of finding, including, savings, unused credit card balances and second mortgages on residences. Eventually, a start-up may seek mezzanine financing, bridge loans and the like. One other source of such financing is venture capital from either: professional venture capitalist (VC) investors who exchange capital for equity in a start-up company; or single or groups of sophisticated individual investors who band together to pool resources in order to create better investing power and are referred to as “Angels.” In either case, however, the National Commission on Entrepreneurship in 2004 reported that of the 600,000 to 800,000 small businesses started each year, only about 1,000 received formal venture capital. However, according to the MoneyTree Survey—a quarterly study of venture capital investment activity in the United States conducted by a collaboration between PricewaterhouseCoopers, Thomson Venture Economics and the National Venture Capital Association—over $21B in equity investments were made in 2004 by professional VC firms (including venture arms of corporations, institutions, investment banks and similar entities) in private companies (representing 2,945 deals). Of that $21B, the companies receiving the top dollar investments were those in the software ($5.1B) and biotechnology ($4B) industries.

Venture capitalists or angels will usually conduct a due diligence process with respect to the start-up. Undoubtedly, the start-up's potential to acquire strong IP rights is a major (and oftentimes, the main) driver of the valuation of the start-up company. The financing discussions will eventually center on what IP does the start-up have, how are they protecting it and the status of each such IP rights procurement. Given the conclusions reached by the CHI Research study cited above, it is not surprising that start-ups with IP rights in hand are valued more highly. In a 2003 speech, Alan Greenspan, the Chairman of the U.S. Federal Reserve, stated that: “In recent decades . . . the fraction of the total output of our economy that is essentially conceptual rather than physical has been rising. This trend has, of necessity, shifted the emphasis in asset valuation from physical property to intellectual property and to the legal rights that inhere in the latter.” Therefore, it is not surprising that companies with strong IP rights fare better in the equity markets thereby producing greater shareholder value.

Consequently, the typical 10-20 times investment return VC's and Angels are typically seeking requires some initial IP and its continued development. However, many times VC's and Angels decide to invest in a start-up without knowing if the IP rights (e.g., patent, copyright, and/or trademark rights) the target start-up company are currently procuring will ever issue—or if they issue, how strong those rights will be (e.g., issuance of a patent with broad claims, issuance of a trademark found to be fanciful-type distinctive, etc.). Such IP rights will directly impact the successfulness of the start-up and hence the likelihood of achieving a return on the money invested in the start-up by a VC or Angel. (One can imagine a scenario where a drug patent does not issue for a biotechnology start-up or a software/business method patent does not issue for a software start-up and how that can effect their respective ability to exclude others from competing by imitation.) Thus, like all investing, there are risk faced by investors (e.g., VCs and Angels) in funding start-up companies.

Thus, given the foregoing, what has not been contemplated and what would be desirable is a financial instrument (e.g., a derivative), and a market for exchanging the same, to allow a VC, Angel or any other investor to hedge the risk associated with an investment in a single high-technology start-up company or a portfolio of investments in a plurality of high-technology start-up companies, where the value of the derivative is related to the likelihood such start-up(s) receive broad IP rights (e.g., a broad patent). In other words, given the foregoing, systems, methods and computer program products for creating, valuating and trading intellectual property rights-based financial instruments are needed.

### SUMMARY OF THE INVENTION

Systems, methods and computer program products for creating, valuating and trading intellectual property rights-based financial instruments are disclosed. The invention, as described below in terms of preferred embodiments, relates to a novel derivative pricing model to account for the value of a company's intellectual property. In one preferred embodiment, an “IP Multiplier” based on metrics is used to rate the strength of potential or actual intellectual property rights.

As described more fully below, the novel pricing model in conjunction with an intellectual property rights-based financial instrument can advantageously be used to hedge against the risk of investing in companies whose value lies primarily in their potential or actual intellectual property rights. In addition, the novel pricing model provides an enhanced and advantageous method of pricing an investment in these companies. Relative liquidity to an investor through the trading of derivatives based on equity investments in non-publicly traded companies is a further advantage of the present invention.

These and other features and advantages of the present invention will be understood or apparent to those of ordinary skill in the art from the drawing and the following detailed description of the preferred embodiments.

### BRIEF DESCRIPTION OF THE DRAWINGS

The features and advantages of the present invention will become more apparent from the detailed description set forth below when taken in conjunction with the drawings in which like reference numbers indicate identical or functionally similar elements. Additionally, the left-most digit of a reference number identifies the drawing in which the reference number first appears.

FIG. 1 is a system diagram of an exemplary environment in which the present invention, in an embodiment, would be implemented.

FIG. 2 is a block diagram of an exemplary computer system useful for implementing the present invention.

### DETAILED DESCRIPTION

I. Overview

In one embodiment, the present invention is a “patent derivative” and a market for exchanging the same, to allow investors (e.g., a VC, Angel, Hedge Fund, Private Equity Firm or the like) to hedge the risk associated with (debt or equity) investments in a single high-technology start-up company or a portfolio of investments in a plurality of high-technology start-up companies. The value of the derivative is related to the likelihood such start-up company(ies) receive a patent (i.e., a patent issues or the patent application is finally rejected or abandoned). In an alternate embodiment, the value of the derivative is based on how “strong” of a patent the start-up receives. It will also be apparent to one skilled in the relevant art(s), after reading the description herein, that the patent derivative of the present invention can be used to hedge on the strength or quality of a future, ultimately-issued patent application based on a present day, pending and unpublished patent application, or based on a published, pending patent application.

As will be appreciated by those skilled in the relevant art(s), the strength of any received patents can be objectively measured (and thus speculated upon) based on one or more of the following factors: the number of total claims, the number of independent claims, the total number of words in the independent claims, the average number of words in the claims, the rating of the law firm which prosecuted the patent, the number of references cited by the applicant, the number of references cited by the Examiner, the total number of cited references, the number of previous patents issued to the named inventors, and/or the like.

In an embodiment of the present invention, an IP trading organization may provide a brokerage desk that makes a market for (i.e., facilitates) patent derivative trades for proprietary trading as well as for clients in order to provide liquidity to such financial instruments. That is, the trading organization would be ready, willing and able to buy or sell patent derivatives as a dealer-market maker and/or dealer-specialist. In such an embodiment, the trading organization would provide an interactive World-Wide Web site accessible via the global Internet for an IP (e.g., patent) index, pricing model, and trade execution services. The IP trading organization may also provide information and data sets that enable traders to identify and capitalize on IP-driven market fluctuations. Such an infrastructure may be an organized exchange for IP-based (patent) derivatives.

Such a system could also allow industries such as investment banking, merchant banking, venture capitalist, hedge funds, private equity funds and the like to intelligently trade and use IP derivatives not only to hedge against IP rights-related market risks, but also to speculate for profit.

The present invention is now described in more detail herein in terms of the above exemplary description. This is for convenience only and is not intended to limit the application or scope of the present invention. In fact, after reading the following description, it will be apparent to one skilled in the relevant art(s) how to implement the following invention in alternative embodiments. For example, it will be apparent to one skilled in the relevant art(s) after reading the description herein that it is possible to create other financial instruments—other than derivatives—based on IP rights other than patent rights. It will also be apparent to one skilled in the relevant art(s), after reading the description herein, that the founders or stakeholders of a start-up company may reduce their exposure (i.e., principal and interest obligations) from receiving debt financing from investors by utilizing the IP-rights derivatives disclosed herein (e.g., an IP-rights-based swap-type derivative).

The terms “user,” “end user”, “investor”, “Angel,” “VC,” “hedge fund,” “bank,” “start-up company,” “small business,” “high-tech company,” “company” and/or the plural form of these terms are used interchangeably throughout herein to refer to any person(s) or entity(ies) capable of accessing, using, be affected by and/or benefiting from the creating, valuating and trading of intellectual property rights-based financial instruments described herein.

As used herein, “security” refers to an investment instrument, other than an insurance policy or fixed annuity, issued by a corporation, government, or other organization which offers evidence of debt or equity, as further defined by the U.S. Securities Exchange Act of 1934, as amended. More specifically, the underlying “security” of the patent derivative provided for by the present invention refers to the instrument evidencing the equity or debt financing an investor (e.g., a VC, Angel, Hedge Fund, Private Equity Firm or the like) has made in a start-up technology company.

As used herein, “intellectual property right” refers to rights under patent, trademark, copyright and trade secret laws, and any other intellectual property, industrial property or proprietary rights recognized in any country or jurisdiction worldwide, including, without limitation, moral rights and similar rights. “Intellectual property right” is differentiated from, and should not be read to mean, the underlying process, machine, manufacture, or composition of matter, etc., protected by the intellectual property (legal) right.

II. System

A. System Architecture Overview

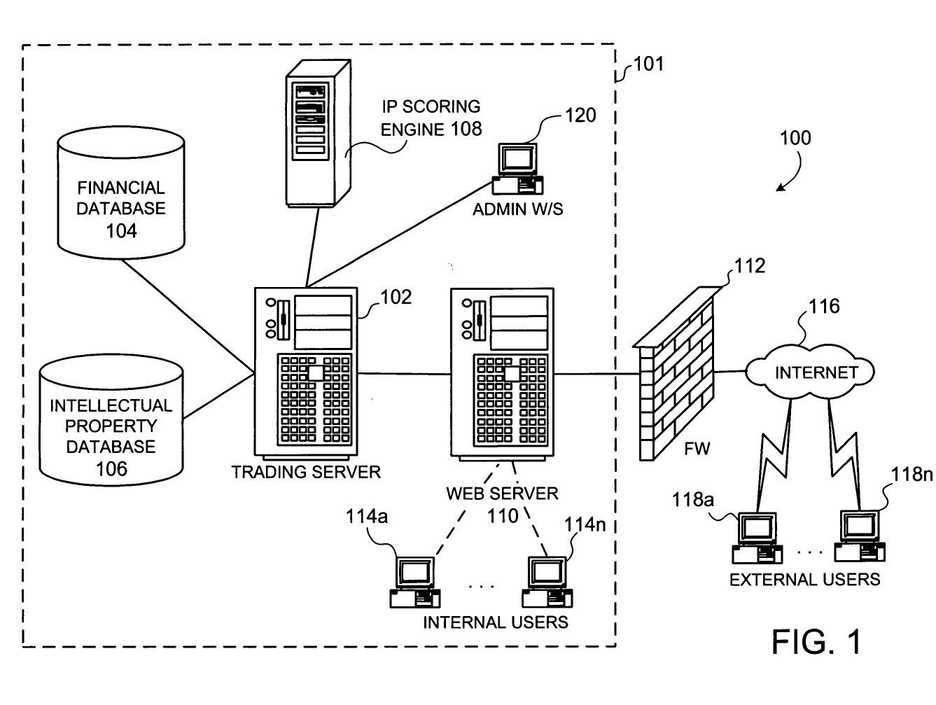

Referring to FIG. 1, an Intellectual Property (IP) trading system 100, according to an embodiment of the present invention, is shown. It should be understood that the particular trading system 100 in FIG. 1 is shown for illustrative purposes only and does not limit the invention. Other implementations for performing the functions described herein will be apparent to persons skilled in the relevant art(s) based on the teachings contained herein, and the invention is directed to such other implementations. As will be apparent to one skilled in the relevant art(s), all components of the trading system 100 are connected and communicate via a communication medium such as a local area network (LAN) 101.

The trading system 100 includes a trading server 102 that serves as the “back-end” (i.e., IP processing system) of the present invention. Connected to trading server 102, is a financial database 104, an IP (i.e., prior art and/or prior IP rights) database 106 and an IP scoring engine 108. Trading server 102 is also connected to a Web server 110. As is well-known in the relevant art(s), a Web server is a server process running at a Web site which sends out web pages in response to Hypertext Transfer Protocol (HTTP) or Hypertext Transfer Protocol, Secured (HTTPS) requests from remote browsers. Web server 110 serves as the “front end” of the present invention. That is, Web server 110 provides the graphical user interface (GUI) to users of trading system 100 in the form of Web pages. Such users may access Web server 110 at a trading organization's or financial exchange's site via a plurality of internal workstations 114 (shown as workstations 114a-n).

A firewall 112 (shown as “FW” 112) serves as the connection and separation between the LAN 101, which includes the plurality of network elements (i.e., elements 102-110 and 120) “inside” of LAN 101, and the global Internet 116 “outside” of the LAN 101. Generally speaking, a firewall—which is well-known in the relevant art(s)—is a dedicated gateway machine with special security precaution software. It is typically used, for example, to service Internet 116 connections and dial-in lines, and protects a cluster of more loosely administered machines hidden behind it from an external invasion.

Global Internet 116, outside of the LAN 101, includes a plurality of external workstations 118 (shown as workstations 118a-n). External workstations 118 allow client-users (traders) of the trading organization or exchange to remotely access and use trading system 100.

Trading system 100 includes an administrative workstation 120 that may be used by the trading organization or exchange to update, maintain, monitor, and log statistics related to the server 102 and the trading system 100 in general.

While one trading server computer 102 is shown in FIG. 1, it will be apparent to one skilled in the relevant art(s) that trading system 100 may be run in a distributed fashion over a plurality of the above-mentioned network elements connected via LAN 101. Similarly, while several databases (i.e., 104 and 106) are shown in FIG. 1, it will be apparent to one skilled in the relevant art(s) that trading system 100 may utilize databases physically located on one or more computers which may or may not be the same as server 102. For example, in alternate embodiments, IP database 108 may be directly connected to scoring engine 106 and provided by a third-party provider to the trading organization (either directly behind firewall 112 or via web server 110 and the Internet 116). More detailed descriptions of the trading system 100 components, as well as their functionality, are provided below.

As used herein, the term “database,” “data sources,” “data store” or similar terms may refer to any type of data organizing mechanism, such as relational databases, hierarchical databases, object-oriented databases, spreadsheets, and/or the like. Common database products that may be used to implement the databases include DB2 by IBM (Armonk, N.Y.), any of the database products available from Oracle Corporation (Redwood Shores, Calif.), Microsoft Access, Microsoft Excel, or SQL Server by Microsoft Corporation (Redmond, Wash.), or any other database product.

Databases may be organized in any suitable manner, including as data tables or lookup tables. Association of certain data may be accomplished through any data association technique known and practiced in the art. For example, the association may be accomplished either manually or automatically. Automatic association techniques may include, for example, a database search, a database merge, GREP, AGREP, SQL, and/or the like. The association step may be accomplished by a database merge function. A “key field” partitions the database according to the high-level class of objects defined by the key field. For example, a certain class may be designated as a key field in both the first data table and the second data table, and the two data tables may then be merged on the basis of the class data in the key field. In this embodiment, the data corresponding to the key field in each of the merged data tables is preferably the same. However, data tables having similar, though not identical, data in the key fields may also be merged by using AGREP, for example. It should also be understood that a system of the present invention is not limited to a physical implementation of a single repository of information. It is also possible to have multiple repositories of information. The multiple repositories may be linked together in a variety of different manners to create a single logical repository of information.

Communication between parties to the transactions contemplated by the present invention and system 100 is accomplished through any suitable communication means, such as, for example, a telephone network, Intranet, Internet, point of interaction device (point of sale device, personal digital assistant, cellular phone, kiosk, etc.), online communications, off-line communications, wireless communications, transponder communications and/or the like.

One skilled in the relevant art(s) will also appreciate that, for security reasons, any databases, systems, or components of the present invention may consist of any combination of databases or components at a single location or at multiple locations, wherein each database or system includes any of various suitable security features, such as firewalls, access codes, encryption, decryption, compression, decompression, and/or the like.

B. IP Database

IP database 108 includes, for the particular type of IP in question, all known issued IP rights issued by one or more relevant government agency(ies). For example, in an embodiment where the financial instrument is based on patent rights, database 108 can be populated from (or be a duplicate of) the publicly available issued patent databases available from the three largest patent offices in the world: the U.S. Patent and Trademark Office (USPTO) (http://www.uspto.gov), the European Patent Office (EPO) (http://ep.espacenet.com) and the Japanese Patent Office (JPO) (http://www.jpo.go.jp/), or any other jurisdictional or private collection of issued patents from one or more of the various patent issuing offices around the world. In one embodiment, such data would be arranged and searchable by internationally-recognized (e.g., WIPO “kind codes” or the like) fields such as one or more of the following: Patent Number, Inventor Name, Issue Date, Inventor City, Title, Inventor State, Abstract, Inventor Country, Claim, Attorney, Agent, Specification, Assignee Name, Classification, Assignee City, Assignee State, Application Number, Assignee Country, Application Date, Examiner, Priority Information, References, Maintenance Fee Status, Annuity Fee Status or Application Type.

As will be appreciated by those skilled in the relevant art(s) after reading the description herein, database 108, in an embodiment, may contain historical data for one or more types of issued IP rights (e.g., patent, trademark, service mark, copyright, etc.) rights accumulated from (i.e., mirroring) the various IP rights offices throughout the world and have the associated fields customarily kept for such IP right types. In an alternate embodiment, database 108 may be populated by a crawler, script, applet, bot, robot or any other computer program product which can “scrape” such information in a batch, real-time or just-in-time fashion from the publicly-available data from the USPTO, EPO, JPO and/or the like.

C. IP Scoring Engine

IP scoring engine 106, in an embodiment, is a module or computer program product that accesses, for the particular type(s) of IP in question, data in IP database 108 or any other data for scoring purposes.

In an embodiment where the present invention provides a “patent derivative” to allow investors (e.g., venture capitalist) to hedge their risk from investing in a high-technology, start-up company with no issued patents, but with one or more pending patent applications, engine 106 can provide an objective (or near-objective) score or metric for any ultimately-issued patent. Such score or metric would be, for example, a numerical (e.g., 0 to 200 scale, dollar value or the like) or letter (e.g., “A+”, “A−”, “B+”, “B−” and the like, or any letter grading system similar to Standard & Poor's or Moody's corporate bond ratings) indication of the ultimately issued patent's “strength” “broadness,” “quality,” “enforceability,” “validity” or any other like positive (yet sometimes subjective) attribute which can correlate to market success of the start-up company's products or services related to the issued patent in question. (As will be appreciated by those skilled in the relevant art(s) after reading the description herein, any patent application abandonment would receive a rating or metric of a numerical zero, a letter rating of “F”, or the like).

In such an embodiment, scoring engine 106 can be commercially supplied (e.g., in an off-the-shelf or ASP-type manner) by such companies as: M-Cam, Inc. of Arlington, Va.; StockPricePredictor.com, LLC of Metuchen, N.J.; Ocean Tomo Patent Ratings LLC of Newport Beach, Calif. (which rates patents using an Intellectual Property Quotient or IPQ™ score of zero to above 200); ipIQ.com of Chicago, Ill.; 1790 Analytics, LLC of Mount Laurel, N.J.; and like companies that provide scoring or metrics of issued utility patents or patent applications based on one or more of measures or pieces of data such as: the number of total claims, the number of independent claims, the total number of words in the independent claims, the average number of words in the claims, the rating of the law firm which prosecuted the patent, the number of references cited by the applicant, the number of references cited by the Examiner, the total number of cited references, the number of previous patents issued to the named inventors, maintenance fee or annuity status, or the like. See, e.g., U.S. Pat. No. 6,556,992 and U.S. Pat. Appl. No. 20040010393A1, incorporated by reference herein in their respective entirety, and disclosing methods of valuating patents.

D. Financial Database

Financial database 104 of trading system 100 contains current financial data that is used by trading server 102. Financial database 104 includes information relevant to calculating an investment's risk-free rate of return. Such information, as will be apparent to one skilled in the relevant art(s), may include but is not limited to one or more of the Discount Rate, the Prime Interest Rate, the 20 and 90-day Treasury Bill, the Federal Funds Rate, the 20-year Treasurer yield, the High-grade corporate bond yield, the high-yield bond rate, the London Interbank Official Rate (LIBOR), the Eurodollar Rate, the 20-year mortgage rate and the like. As will be explained below, the risk-free rate information within financial database 104 is necessary for determining the cost-of-cash during the operation of trading system 100. Financial database 104 may include additional financial information on an application-specific basis.

III. Process

Below are the details of the Black-Scholes pricing model. It is noted that, for illustrative purposes only, the invention is described with reference to the Black-Scholes pricing model. However, the invention is not limited to this embodiment. Rather, embodiments of the invention may utilize other pricing models. The following description applies to such other embodiments of the invention.

The Black-Scholes formula for determining the theoretical call premium, C, using the five parameters essential to the pricing of an option: the strike price K; the time to expiration t; the underlying commodity price S; the volatility of the commodity a (“sigma”); and the risk-free interest rate r (e.g., 20-day Treasury Bill yield), is shown in the following equation:
C=S*N(d1)−Ke^{-(rt)}*N(d2)
As will be apparent to one skilled in the relevant art(s), e is the exponential function—the inverse of the natural logarithm (ln)—that is equal to, up to seven significant decimal places, 2.7182818, and the function N( ) is the cumulative standard normal distribution, which, as is also well known in the relevant art(s). Lastly, the variables d1 and d2 in the above equation are calculated as:

$$d 1 = \frac{ln ( S / K ) + ( r + \frac{{σ}^{2}}{2} ) * t}{σ \sqrt{t}} ; and d 2 = d 1 - σ \sqrt{t}$$

Having presented the Black-Scholes formula for a call option, the following equation describes the expression for the price P of a put option:
P=C−S+Ke^{-(rt)}
It should be noted that, as will be appreciated by those skilled in the relevant art(s), the Black-Scholes pricing model makes the assumption that the stock pays no dividends during the option's life. While this may distort the model for companies whose stock are publicly-traded and pay dividends (a higher dividend yield would elicit a lower call premium), this is most certainly not be the case for a pre-IPO start-up company in which an investor (e.g., a VC) makes an equity investment.

Having presented the Black-Scholes pricing model, the operation of the present invention and its application to pricing IP rights-based financial instruments may now be explained. However, as indicated above, while the present invention is described in terms of adopting the Black-Scholes model to include weather considerations, it will be apparent to one skilled in the relevant art(s) after reading the description herein, that other pricing models may be so adopted. For example, in alternate embodiments, some variant of the binomial option pricing model is used as described in Cox, John C., et al., “Option Pricing: A Simplified Approach,” Journal of Financial Economics 7, 229-63, which is hereby incorporated by reference in its entirety.

Generally speaking, a method for valuating a potential intellectual property right-based financial instrument (e.g., a patent derivative), according to one embodiment of the present invention, includes the steps of:

(1) receiving information representative of a maturity date for a financial instrument;

(2) receiving information representative of an underlying (equity or debt) security which serves as the basis for the derivative;

(3) receiving information representative of a potential intellectual property right (e.g., a USPTO, EPO, JPO or the like patent application number that is pending);

(4) receiving information representative of a risk-free rate (e.g., 20-day T-bill);

(5) receiving a metric related to the potential intellectual property right (e.g., an Ocean Tomo IPQ score for a pending patent application), the metric being calculated based on a plurality of characteristics of the pending patent application (as though it were a granted patent); and

(6) determining a value for the financial instrument by applying a pricing model (e.g., Black-Scholes or the like), the pricing model utilizing at least a price for the underlying security, the maturity date, the risk-free rate and the metric.

In must be noted, before detailing the present invention any further, and using the USPTO as an example and source of information, the average total pendency of a patent application (i.e., the wait time for awarding a patent measured from the time the application is first filed) was over 27 months in 2004. The 2004 average total pendency for software, biotech and communications patent applications, however, was 41 months, 29.9 months and 40.5 months, respectively. Further still, the allowance rate for patent application can vary widely by year and technology sector. For example, in 2000 the overall patent application allowance rate was approximately 67%, however in 2001, but the rate was only 45% for business method patents. In 2004, the allowance rate for business method patents was just 11%. Consequently, as will be appreciated by those skilled in the relevant art(s) after reading the description herein, the pricing model will be affected by the above (and thus, the metric of any granted patent—if any—and the overall price of the financial instrument).

A detailed patent derivative creation and valuation process, according to one embodiment of the present invention, is now explained.

In an embodiment, an entity (e.g., a private equity firm) makes an equity investment in a technology-based private (start-up) company and receives a number of shares, each share having a share price S. Such an investment, however, is illiquid. Therefore, the entity may chose to create a financial instrument (e.g., a call option) based on such shares, and price the premium of that call option, C, using a pricing model (e.g., the Black Scholes model). The option would have a strike price K; a risk-free interest rate r (e.g., 20-day Treasury Bill yield) and the time to expiration of the option t.

The volatility of the stock, σ, is not available because the stock is that of a private company and thus not publicly traded. Thus, in one embodiment, a can be the median volatility of a basket of (e.g., five to ten) public “small cap” or “medium cap” companies in a similar industry sector (e.g., telecommunications, biotechnology, software, etc.). In an alternate embodiment, the median volatility of the Russell® 2000 Index (maintained by the Frank Russell Company of Tacoma, Wash.) may be used. In yet another embodiment, the median volatility of the companies within the Russell 2000 or Russell 3000 in a similar industry sector to the company in question may be used. Similarly, and in an alternate embodiments, the present invention may use the actual (relatively static) price of the company's non-publicly traded stock S or use a basket (e.g., five to ten) of public “small cap” or “medium cap” companies in a similar industry sector (e.g., telecommunications, biotechnology, software, etc.).

The company's success (and thus, the success of the VC's investment) may depend on a potential IP right (e.g., a pending patent application). Thus, according to the present invention, an “IP multiplier” is factored into the pricing model along with the (relatively static) price of the company's non-publicly traded stock S. In an embodiment, the IP multiplier is based on an objective metric related to the potential intellectual property right the company possesses. Thus, in an embodiment, an IPQ score—which ranges from 0 to 200, with a mean of 100—is utilized as part of the IP multiplier. In one embodiment the IP Multiplier, I, is given by the following equation:

$$I = \frac{{IPQ}_{Company}}{{IPQ}_{Class}} * {P}_{Issuance}$$

Where IPQ_{Company} is the current IPQ score of the company's pending patent application received from IP scoring engine 106; IPQ_{Class} is the mean IPQ score of all issued patents and/or published patent applications in the same USPTO class or same International Patent Classification as the company's pending patent application in question; and P_{Issuance} is a calculated probability that the company's pending patent application will eventually issue as a patent. In one embodiment, P_{Issuance} is set to 0, if the patent application is finally rejected or abandoned; 1, if the patent application has received a notice of allowance; or (N(z)*factor) otherwise. In such an embodiment, N( ) is the cumulative standard normal distribution function and:

$$z = \frac{ABS \vert {t}_{pending} - {t}_{mean} \vert}{δ}$$

Where t_{pending} is the amount of time the company's patent application has been pending; tₘₑₐₙ is the mean pending time for all patent applications in the same USPTO class or same International Patent Classification as the company's pending patent application (as published by the respective national patent offices); δ is the standard deviation calculated when calculating tₘₑₐₙ; and factor is set to 1 if the company's pending patent application has not yet received a first Office action rejecting any claims from the USPTO (or foreign patent office equivalent), or else, factor is set to 0.5 if a first Office action rejecting any claims from the USPTO (or foreign patent office equivalent) has been received.

In such an embodiment, setting P_{Issuance} equal to (N(z)*factor) assumes that the pendency rate of patent applications within a class are normally distributed and that the closer an individual application's t_{pending} gets to tₘₑₐₙ (both on the front and back ends of tₘₑₐₙ), the closer the application gets to issuance (and hence a higher probability of receiving any IP rights). Conversely, setting P_{Issuance} equal to (N(z)*factor) assumes that the pendency rate of patent applications within a class are normally distributed, and that the farther an individual application's t_{pending} gets away from tₘₑₐₙ (both on the front and back ends of tₘₑₐₙ) the farther the application is to issuance (and hence a lower probability of receiving any IP rights).

Further, in such an embodiment, factor is set to 1 if the company's pending patent application has not yet received a first Office action rejecting any claims from the USPTO (or foreign patent office equivalent), or else, factor is set to 0.5 if a first Office action rejecting any claims from the USPTO (or foreign patent office equivalent) has been received. This presumes that if an Office action has not yet been received, there is a higher probability of receiving some IP rights. Conversely, the present invention presumes there is a lower probability of receiving (strong) IP rights if an Office action rejecting one or more claims has been issued in the pending patent application in question. In alternate embodiments, factor may be set to a value between 0 and 1 based upon one or more of the following: the number of office actions, the percentage of rejected independent claims versus total claims, the percentage of rejected independent claims versus total independent claims, the average allowance rate of patent applications in the same class or same International Patent Classification as the company's pending patent application in question, or the like.

Further, the present invention presumes that patent applicants (especially those whose company stock may be the underlying security for the financial instruments disclosed herein) would not file patent applications with unreasonably broad claims to distort the IP Multiplier, L This is true especially in the U.S. and like jurisdictions where amending the claims significantly during prosecution can have very adverse effects to any eventual patent rights (and thus post-allowance IPQ scores) under such legal doctrines as prosecution history estoppel. (See Festo Corp. v. Shoketsu Kinzoku Kogyo Kabushiki Co., 535 U.S. 722 (2002).)

In sum, because studies show that a (start-up) company's success (and thus, the success of a VC's investment in such company) is dependent on the company's potential IP rights (e.g., a pending patent application), the present invention introduces an “IP multiplier” factored into a pricing model for a derivative (e.g., a call option) with the company's non-publicly traded stock as the underlying asset. Using the well-known Black-Scholes pricing model, the premium is calculated as:
C=(I*S)*N(d1)−Ke^{-(rt)}*N(d2)
where I is calculated (for a pending, non-finally rejected, non-issues, non-abandoned, patent application—where P_{Issuance} is not 0 or 1) as follows:

$$I = \frac{{IPQ}_{Company}}{{IPQ}_{Class}} * N ( \frac{ABS \vert {t}_{pending} - {t}_{mean} \vert}{δ} ) * factor$$

The value of a put option premium, P, can then be calculated accordingly as described above.

As will be appreciated by those skilled in the relevant art(s) after reading the description herein, the IPQ score or any other third-party objective metric of a patent or patent application is dynamic, as is the volatility and risk-free rate. Thus, the value of the call or put option premium would fluctuate based on both financial market and IP-related conditions. As will be appreciated by those skilled in the relevant art(s) after reading the description herein, the private (start-up) company may have a plurality of patent applications pending. Thus, in one embodiment, the option premium may be calculated for all, one or a subset of patent applications in the company's portfolio (e.g., only certain “key” patents, only “core” patents, etc.), and the IP Multiplier, I, would then be calculated using an arithmetic mean or average for the variables used to determine I (i.e., factor, IPQ_{Company}, IPQ_{Class}, tₘₑₐₙ, t_{pending}, etc.).

The present invention thus provides relative liquidity to an investor through the trading of derivatives based on an equity investment in a non-publicly traded company, and by factoring the marketplace's recognition that potential IP rights (especially patent rights) and the realization of those potential rights greatly affect the success of private, start-up (i.e., pre-IPO) companies.

It will be apparent to persons skilled in the relevant art(s) (e.g., computer science, intellectual property law, financial markets and/or the like) that various changes in values for factor, IPQ_{Company}, tₘₑₐₙ, P_{Issuance}, and the like, can be made therein without departing from the spirit and scope of the present invention. Further, in alternate embodiments, as will be apparent to those skilled in the relevant art(s) after reading the description herein, the methodology described above may be implemented for an entity whose stock is publicly-traded. In such an embodiment, the actual volatility of the stock, σ, would be employed in valuing any derivative, and the average or mean IPQ score of that company's IP portfolio would be used in determining the IP Multiplier, I (whether all pending patent applications, all issued patents, a subset of “core” pending patent applications, a subset of “core” issued patents, a subset of pending patent applications in one or more classes, all issued patents in one or more classes, and/or the like). In a further embodiment, rather than employing the mean or average IPQ of a company's IP portfolio, the Pipeline Quality index created and provided by 1790 Analytics, LLC of Mount Laurel, N.J., may be utilized in determining IP Multiplier, I.

IV. Alternate IP-Rights Derivative Embodiments

In an alternate embodiment, the present invention provides for a “Forward Contract”-type IP rights derivative. In a conventional Forward Contract, the purchaser and its counterparty are obligated to trade an asset at a specified date in the future. In such an embodiment, however, the underlying asset is an instrument evidencing the equity (or debt) financing an investor has made in a high-tech, start-up company and the specified date can be the date of a specific patent application issuance or final abandonment. Thus, in one exemplary embodiment, a contract would be structured such that a strike price for the underlying equity asset would be set at $20/share if the company's pending application (pool of applications) achieved an IPQ score less than 150 once it issues, but the strike price would be set at $30/share if the company's pending application (or pool of applications) achieved an IPQ score greater than or equal to 150 once it issues.

In an alternate embodiment, the present invention provides for an “IP rights convertible bond.” In such an embodiment, like conventional convertible bonds, it may be exchanged, at the option of the holder, for a specific number of shares of a company's preferred stock or common stock. In such an embodiment, however, the bond's maturity date can be the date of a specific patent application issuance or final abandonment. Further, the conversion price would be determined based on the rating or metric (e.g., IPQ) of the patent issuing from a specific patent application filed by the company in question. For example, the conversion price may be set at $20/share if the company's pending application (pool of applications) achieved an IPQ score less than 150 once it issues, or be set at $30/share if the company's pending application (or pool of applications) achieved an IPQ score greater than or equal to 150 once it issues. (In a further embodiment, the discount rate for such a bond can also be based on a metric such as an IPQ.)

In an alternate embodiment, the present invention provides for a “Structured Note”-type IP rights derivative. In such an embodiment, the Structured Note is a debt instrument (e.g., an investor's private placement debt financing of a company) where the principal and/or the interest rate is indexed to an unrelated indicator such as the rating or metric (e.g., IPQ) of the patent or pool of patents attained by the company's patent application(s) or other potential IP rights (with the understanding that any patent application abandonment would receive a rating or metric of a numerical zero, a letter rating of “F”, or the like). In such an embodiment, the two elements of the Structured Note are inversely proportionally related, so as the index goes up (e.g., the IPQ of the issued patent or average IPQ of the patent pool), the rate of payment (i.e., the “coupon rate”) goes down.

In yet another embodiment, a (private or public) company may issue two classes of stock—a class A and a Class B. Class A stock would be a “regular” class of common stock representing an (fractional) ownership interest in the company as a whole (i.e., all its assets and liabilities). However, in such an embodiment, the “Class B” stock would represent a direct (fractional) ownership only in the company's intellectual property rights portfolio—both issued and potential (i.e., pending) or an identified portion thereof. That is, for example, Class B shareholders would own a direct (fractional) ownership in the value of company's IP portfolio and earnings per share for the Class B shares would be measured by one or more of the following: the value or potential value (i.e., using a metric such as IPQs or Pipeline Quality) of the IP portfolio; actual earnings from IP (e.g., patent, copyright, trademark, know-how, etc.) royalties and license fees; or actual earnings from the sale of any IP rights in the IP portfolio (whether by direct sale, sale/lease back, auction, etc.). In such an embodiment, the Class B shares can be publicly traded as is common stock. Thus, as will be apparent to one skilled in the relevant art(s) after reading the description herein, derivatives based on such Class B stock can be created and valued as described herein (e.g., Section IV).

V. Example Implementations

The present invention (i.e., system 100, the processes described herein or any part(s) or function(s) thereof) may be implemented using hardware, software (Visual Basic, C++, Excel, etc.) or a combination thereof and may be implemented in one or more computer systems or other processing systems. However, the manipulations performed by the present invention were often referred to in terms, such as adding or comparing, which are commonly associated with mental operations performed by a human operator. No such capability of a human operator is necessary, or desirable in most cases, in any of the operations described herein which form part of the present invention. Rather, the operations are machine operations. Useful machines for performing the operation of the present invention include general purpose digital computers or similar devices.

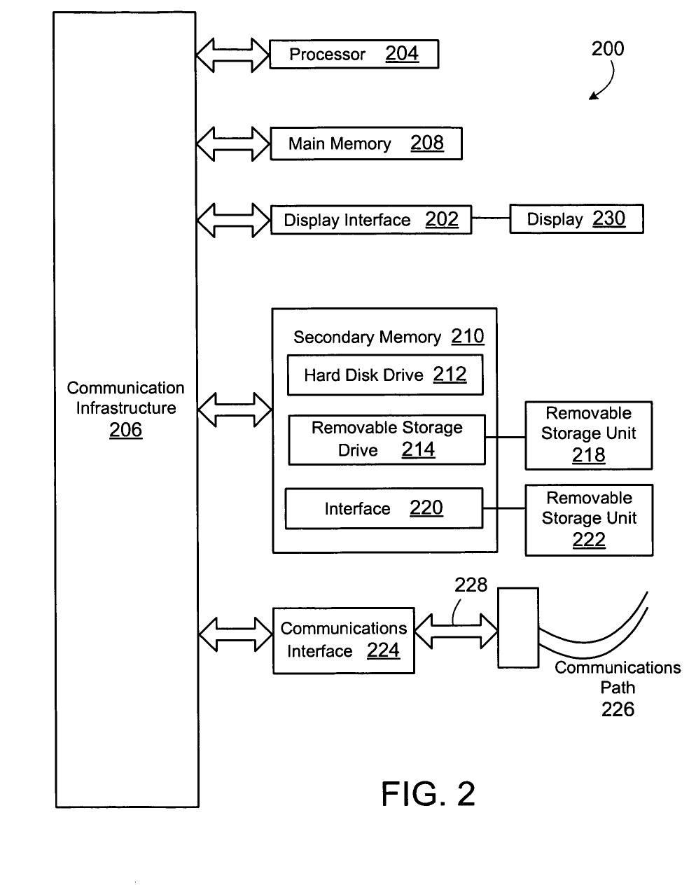

In fact, in one embodiment, the invention is directed toward one or more computer systems capable of carrying out the functionality described herein. An example of a computer system 200 is shown in FIG. 2.

The computer system 200 includes one or more processors, such as processor 204. The processor 204 is connected to a communication infrastructure 206 (e.g., a communications bus, cross-over bar, or network). Various software embodiments are described in terms of this exemplary computer system. After reading this description, it will become apparent to a person skilled in the relevant art(s) how to implement the invention using other computer systems and/or architectures.

Computer system 200 can include a display interface 202 that forwards graphics, text, and other data from the communication infrastructure 206 (or from a frame buffer not shown) for display on the display unit 230.

Computer system 200 also includes a main memory 208, preferably random access memory (RAM), and may also include a secondary memory 210. The secondary memory 210 may include, for example, a hard disk drive 212 and/or a removable storage drive 214, representing a floppy disk drive, a magnetic tape drive, an optical disk drive, etc. The removable storage drive 214 reads from and/or writes to a removable storage unit 218 in a well known manner. Removable storage unit 218 represents a floppy disk, magnetic tape, optical disk, etc. which is read by and written to by removable storage drive 214. As will be appreciated, the removable storage unit 218 includes a computer usable storage medium having stored therein computer software and/or data.

In alternative embodiments, secondary memory 210 may include other similar devices for allowing computer programs or other instructions to be loaded into computer system 200. Such devices may include, for example, a removable storage unit 222 and an interface 220. Examples of such may include a program cartridge and cartridge interface (such as that found in video game devices), a removable memory chip (such as an erasable programmable read only memory (EPROM), or programmable read only memory (PROM)) and associated socket, and other removable storage units 222 and interfaces 220, which allow software and data to be transferred from the removable storage unit 222 to computer system 200.

Computer system 200 may also include a communications interface 224. Communications interface 224 allows software and data to be transferred between computer system 200 and external devices. Examples of communications interface 224 may include a modem, a network interface (such as an Ethernet card), a communications port, a Personal Computer Memory Card International Association (PCMCIA) slot and card, etc. Software and data transferred via communications interface 224 are in the form of signals 228 which may be electronic, electromagnetic, optical or other signals capable of being received by communications interface 224. These signals 228 are provided to communications interface 224 via a communications path (e.g., channel) 226. This channel 226 carries signals 228 and may be implemented using wire or cable, fiber optics, a telephone line, a cellular link, an radio frequency (RF) link and other communications channels.

In this document, the terms “computer program medium” and “computer usable medium” are used to generally refer to media such as removable storage drive 214, a hard disk installed in hard disk drive 212, and signals 228. These computer program products provide software to computer system 200. The invention is directed to such computer program products.

Computer programs (also referred to as computer control logic) are stored in main memory 208 and/or secondary memory 210. Computer programs may also be received via communications interface 224. Such computer programs, when executed, enable the computer system 200 to perform the features of the present invention, as discussed herein. In particular, the computer programs, when executed, enable the processor 204 to perform the features of the present invention. Accordingly, such computer programs represent controllers of the computer system 200.

In an embodiment where the invention is implemented using software, the software may be stored in a computer program product and loaded into computer system 200 using removable storage drive 214, hard drive 212 or communications interface 224. The control logic (software), when executed by the processor 204, causes the processor 204 to perform the functions of the invention as described herein.

In another embodiment, the invention is implemented primarily in hardware using, for example, hardware components such as application specific integrated circuits (ASICs). Implementation of the hardware state machine so as to perform the functions described herein will be apparent to persons skilled in the relevant art(s).

In yet another embodiment, the invention is implemented using a combination of both hardware and software.

VI. Conclusion

While various embodiments of the present invention have been described above, it should be understood that they have been presented by way of example, and not limitation. It will be apparent to persons skilled in the relevant art(s) (e.g., computer science, intellectual property law, financial markets and/or the like) that various changes in form and detail can be made therein without departing from the spirit and scope of the present invention (e.g., equity/debt investments, different IP metrics, etc.). Thus, the present invention should not be limited by any of the above described exemplary embodiments, but should be defined only in accordance with the following claims and their equivalents.

In addition, it should be understood that the figures, which highlight the functionality and advantages of the present invention, are presented for example purposes only. The architecture of the present invention is sufficiently flexible and configurable, such that it may be utilized (and navigated) in ways other than that shown in the accompanying figures.

Further, the purpose of the foregoing Abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The Abstract is not intended to be limiting as to the scope of the present invention in any way.

What is claimed is:

1. A method for valuating a potential intellectual property right-based financial instrument, comprising the steps of:
(a) receiving information representative of a maturity date for a financial instrument;
(b) receiving information representative of an underlying security which serves as the basis for said financial instrument;
(c) receiving information representative of a potential intellectual property right;
(d) receiving information representative of a risk-free rate;
(e) receiving a metric related to said potential intellectual property right, said metric being calculated based on a plurality of characteristics of said potential intellectual property right; and
(f) determining a value for said financial instrument by applying a pricing model, said pricing model utilizing at least a price for said underlying security, said maturity date, said risk-free rate and said metric;
whereby said financial instrument may be used to hedge against the risk of investing in said underlying security issued by a company which applied for said potential intellectual property right.

2. The method of claim 1, wherein said pricing model is the Black-Scholes pricing model.

3. The method of claim 2, wherein said metric is a numerical value ranging from 0 to 200, wherein said metric is an objective indicia of the strength or quality of said potential intellectual property right.

4. The method of claim 2, wherein said potential intellectual property right is a pending utility patent application.

5. The method of claim 4, wherein said plurality of characteristics of said potential intellectual property right includes at least one of: the number of total claims, the number of independent claims, the total number of words in the independent claims, or the average number of words in the claims.

6. The method of claim 4, wherein said underlying security is an equity investment in a company.

7. The method of claim 4, wherein said underlying security is a debt investment in a company.

8. The method of claim 2, wherein said potential intellectual property right-based financial instrument is a call option contract.

9. The method of claim 2, wherein said potential intellectual property right-based financial instrument is a put option contract.

10. The method of claim 2, wherein said potential intellectual property right-based financial instrument is a forward contract.

11. The method of claim 2, wherein said potential intellectual property right-based financial instrument is a swap.

12. The method of claim 2, wherein said potential intellectual property right-based financial instrument is a structured note.

13. The method of claim 1, wherein said pricing model is the binomial option pricing model.

14. The method of claim 1, wherein said underlying security is at least one share of a class of stock that represents a direct, fractional ownership in the value of an IP rights portfolio owned by the company issuing said at least one share.

15. The method of claim 1, wherein:
said potential intellectual property right is a pending utility patent application;
said metric is an IPQ score; and
said pricing model is the Black-Scholes pricing model.

16. The method of claim 15, wherein said step (f) comprises the steps of:
(f1) obtaining an IPQ score, IPQ_{Company}, for said pending utility patent application;
(f2) obtaining a mean IPQ score, IPQ_{Class}, for one of: a plurality of issued patents, a plurality of published patent applications, or a plurality of issued patents and published patent applications; in the same class as said pending utility patent application;
(f3) calculating a probability, P_{Issuance}, that said pending patent application will eventually issue as a patent; and
(f4) calculating an IP Multiplier, I, using the formula:
$$I = \frac{{IPQ}_{Company}}{{IPQ}_{Class}} * {P}_{Issuance} ;$$
whereby said IP Multiplier, I, is introduced into the Black-Scholes pricing model to account for said pending patent application when determining a value for said financial instrument.

17. A system for valuating a financial instrument, based upon a portfolio of intellectual property rights, comprising:
means for receiving information representative of a maturity date for a financial instrument;
means for receiving information representative of an underlying security which serves as the basis for said financial instrument;
means for receiving information representative of a portfolio of intellectual property rights;
means for receiving information representative of a risk-free rate;
means for receiving a metric related to said portfolio of intellectual property rights, said metric being calculated based on a plurality of characteristics of said portfolio of intellectual property rights; and
means for determining a value for said financial instrument by applying a pricing model, said pricing model utilizing at least a price for said underlying security, said maturity date, said risk-free rate and said metric.

18. A computer program product comprising a computer usable medium having control logic stored therein for causing a computer to valuate a potential intellectual property right-based financial instrument, said control logic comprising:
first computer readable program code means for causing the computer to receive information representative of a maturity date for a financial instrument;
second computer readable program code means for causing the computer to receive information representative of an underlying security which serves as the basis for said financial instrument;
third computer readable program code means for causing the computer to receive information representative of a potential intellectual property right;
fourth computer readable program code means for causing the computer to receive information representative of a risk-free rate;
fifth computer readable program code means for causing the computer to receive a metric related to said potential intellectual property right, said metric being calculated based on a plurality of characteristics of said potential intellectual property right; and
sixth computer readable program code means for causing the computer to calculate a value for said financial instrument by applying a pricing model, said pricing model utilizing at least a price for said underlying security, said maturity date, said risk-free rate and said metric;
whereby said financial instrument may be used to hedge against the risk of investing in said underlying security issued by a company which applied for said potential intellectual property right.

19. The computer program product of claim 18, wherein said potential intellectual property right-based financial instrument is a call option contract.

20. The computer program product of claim 19, wherein said potential intellectual property right is a pending utility patent application.

21. The computer program product of claim 20, wherein said metric is an IPQ score; and said pricing model is the Black-Scholes pricing model.
